(19) United States
(12) Patent Application Publication
(10) Pub. No.: US 2013/0028140 A1
(43) Pub. Date: Jan. 31, 2013

(54) USING SERVICE DISCOVERY TO BUILD ROUTING TOPOLOGIES

(71) Applicants: Jonathan W. Hui, Foster City, CA (US); Jean-Philippe Vasseur, Saint Martin d'Uriage (FR)

(72) Inventors: Jonathan W. Hui, Foster City, CA (US); Jean-Philippe Vasseur, Saint Martin d'Uriage (FR)

(73) Assignee: CISCO TECHNOLOGY, INC., San Jose, CA (US)

(21) Appl. No.: 13/192,955

(22) Filed: Jul. 28, 2011

(51) Int. Cl. H04L 12/28

(52) U.S. Cl. 370/255; 370/254

(57) ABSTRACT

In one embodiment, a particular route optimizing device of a computer network (e.g., an NMS or a device in the network) discovers one or more registered services for the computer network, the registered services indicating one or more corresponding routing characteristics associated with the respective registered service. By comparing the one or more service-related routing characteristics with a current routing characteristic of a routing topology of the computer network (where the routing topology built based on a current routing topology strategy), it can be determined whether to update the routing topology strategy based on the comparison. In response to determining to update the routing topology strategy, one or more devices in the computer network may then be informed of an updated routing topology strategy and associated service-related routing characteristics, where the one or more devices are configured to update the routing topology based on the updated routing topology strategy, accordingly.

### TECHNICAL FIELD

The present disclosure relates generally to computer networks, and, more particularly, to building routing topologies in computer networks.

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability, etc. One example routing solution to LLN challenges is a protocol called Routing Protocol for LLNs or “RPL,” which is a distance vector routing protocol that builds a Destination Oriented Directed Acyclic Graph (DODAG, or simply DAG) in addition to a set of features to bound the control traffic, support local (and slow) repair, etc. The RPL architecture provides a flexible method by which each node performs DODAG discovery, construction, and maintenance.

Resource constraints typical to LLNs imply that routing topologies must often make a tradeoff between state requirements and routing “stretch.” For example, a non-storing mode minimizes state at intermediate devices, but requires all traffic to traverse the DAG root. A storing mode stores shortest paths within a network, but still requires paths to follow the DAG. Generally, a single DAG instance is optimized according to a single Objective Function, and though additional DAG instances may be used to support different routing topologies optimized using different Objective Functions, doing so requires additional state and communication overhead.

Routing requirements of a given network often depend upon the particular applications running in the network. More precisely, the services that operate in the network may define the communication requirements across the network, as each service may have its own reliability, throughput, latency, or energy requirements, where the particular devices on which a service is hosted define the communication end-points of a service. Currently, however, such configuration is manual, cumbersome, and non-adaptive.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device/node;

FIG. 3 illustrates an example message format;

FIG. 4 illustrates an example directed acyclic graph (DAG) in the computer network of FIG. 1;

FIG. 5 illustrates an example of service hosts and clients in the network of FIG. 1;

FIG. 6 illustrates an example of a service registration;

FIG. 7 illustrates an example of service requests;

FIG. 8 illustrates an example of service replies;

FIG. 9 illustrates an example of an updated routing topology;

FIG. 10 illustrates another example of an updated routing topology (e.g., a local DAG); and

FIG. 11 illustrates an example simplified procedure for building a routing topology using service discovery.

### DESCRIPTION OF EXAMPLE EMBODIMENTS

### Overview

According to one or more embodiments of the disclosure, a particular route optimizing device of a computer network (e.g., a network management service or “NMS” or else a device in the network) discovers one or more registered services for the computer network, the registered services indicating one or more corresponding routing characteristics associated with the respective registered service. By comparing the one or more service-related routing characteristics with a current routing characteristic of a routing topology of the computer network (where the routing topology built based on a current routing topology strategy), it can be determined whether to update the routing topology strategy based on the comparison. In response to determining to update the routing topology strategy, one or more devices in the computer network may then be informed of an updated routing topology strategy and associated service-related routing characteristics, where the one or more devices are configured to update the routing is topology based on the updated routing topology strategy, accordingly.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routes (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth. Correspondingly, a reactive routing protocol may, though need not, be used in place of a proactive routing protocol for smart object networks.

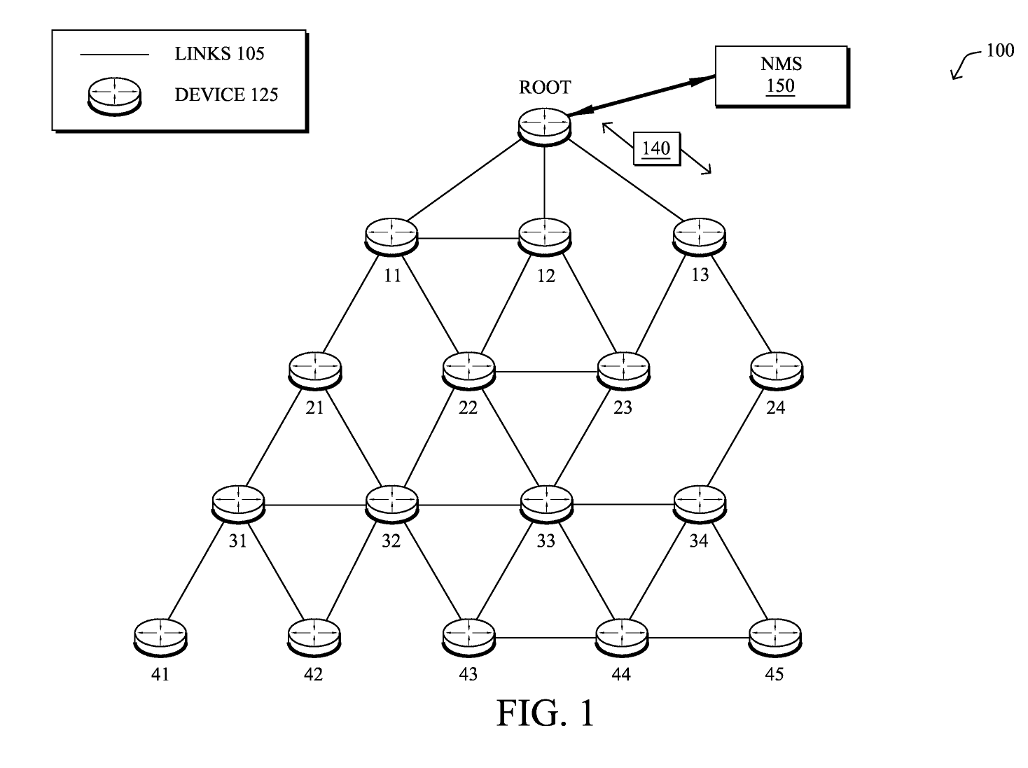

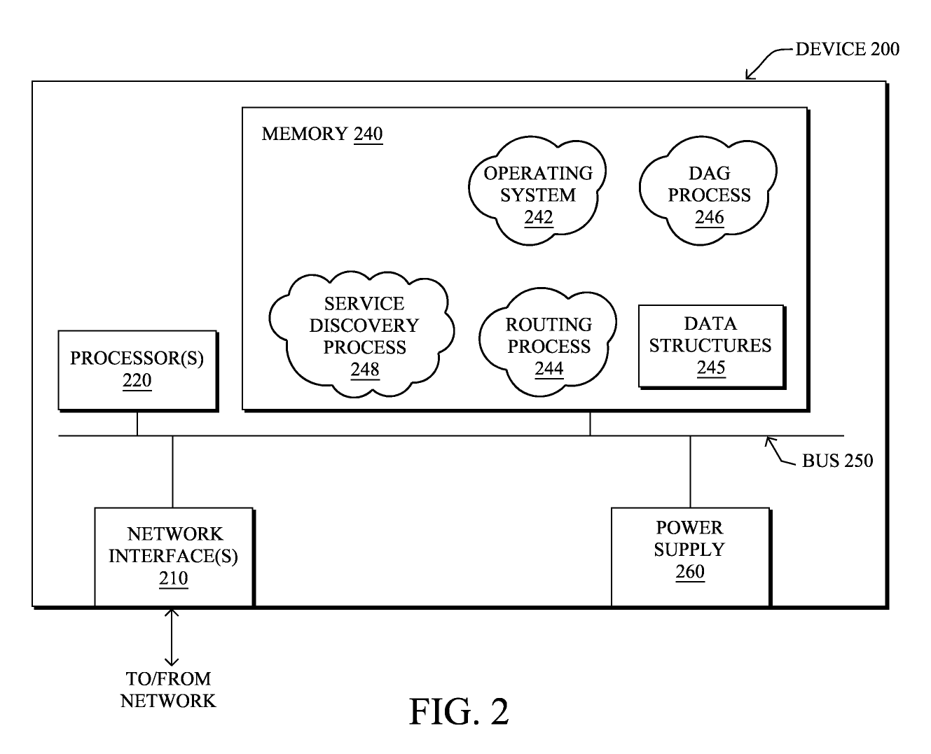

FIG. 1 is a schematic block diagram of an example computer network 100 illustratively comprising nodes/devices 125 (e.g., labeled as shown, “root,” “11,” “12,” . . . “45,” and described in FIG. 2 below) interconnected by various methods of communication. For instance, the links 105 may be wired links and/or shared media (e.g., wireless links, PLC links, etc.), where certain nodes 125, such as, e.g., routers, sensors, computers, etc., may be in communication with other nodes 125, e.g., based on distance, signal strength, current operational status, location, etc. In addition, an illustrative network management service (NMS) device 150 is shown in communication with the root device, e.g., via a global network such as a WAN. Those skilled in the art will understand that any number of nodes, devices, links, etc. may be used in the computer network, and that the view shown herein is for simplicity.

Data packets 140 (e.g., traffic and/or messages sent between the devices/nodes) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes 125 shown in FIG. 1 above, as well as the NMS device 150. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise necessary elements or logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244, a directed acyclic graph (DAG) process 246, and an illustrative service discovery process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example protocol specified in an Internet Engineering Task Force (IETF) Internet Draft, entitled “RPL: IPv6 Routing Protocol for Low Power and Lossy Networks”<draft-ietf-roll-rpl-19> by Winter, at al. (Mar. 13, 2011 version), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are is oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by DAG process 246) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF Internet Draft, entitled “Routing Metrics used for Path Calculation in Low Power and Lossy Networks”<draft-ietf-roll-routing-metrics-19> by Vas seur, et al. (Mar. 1, 2011 version). Further, an example OF (e.g., a default OF) may be found in an IETF Internet Draft, entitled “RPL Objective Function 0”<draft-ietf-roll-of 0-15> by Thubert (Jul. 8, 2011 version) and “The Minimum Rank Objective Function with Hysteresis”<draft-ietf-roll-minrank-hysteresis-of-04> by 0. Gnawali et al. (May 17, 2011 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

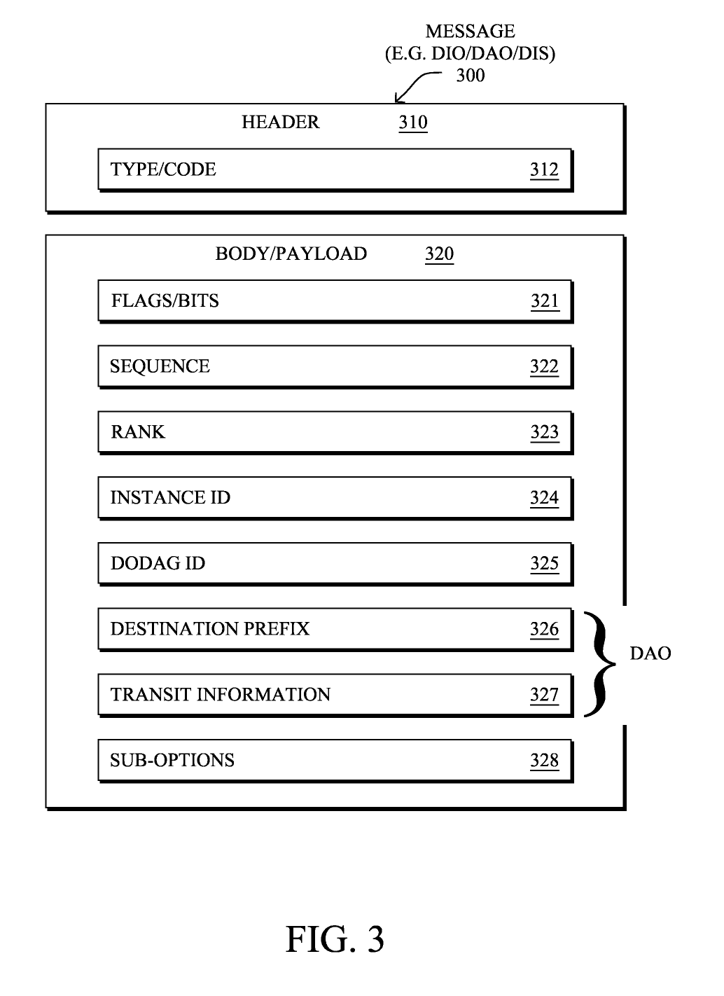

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (e.g., DAO_Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

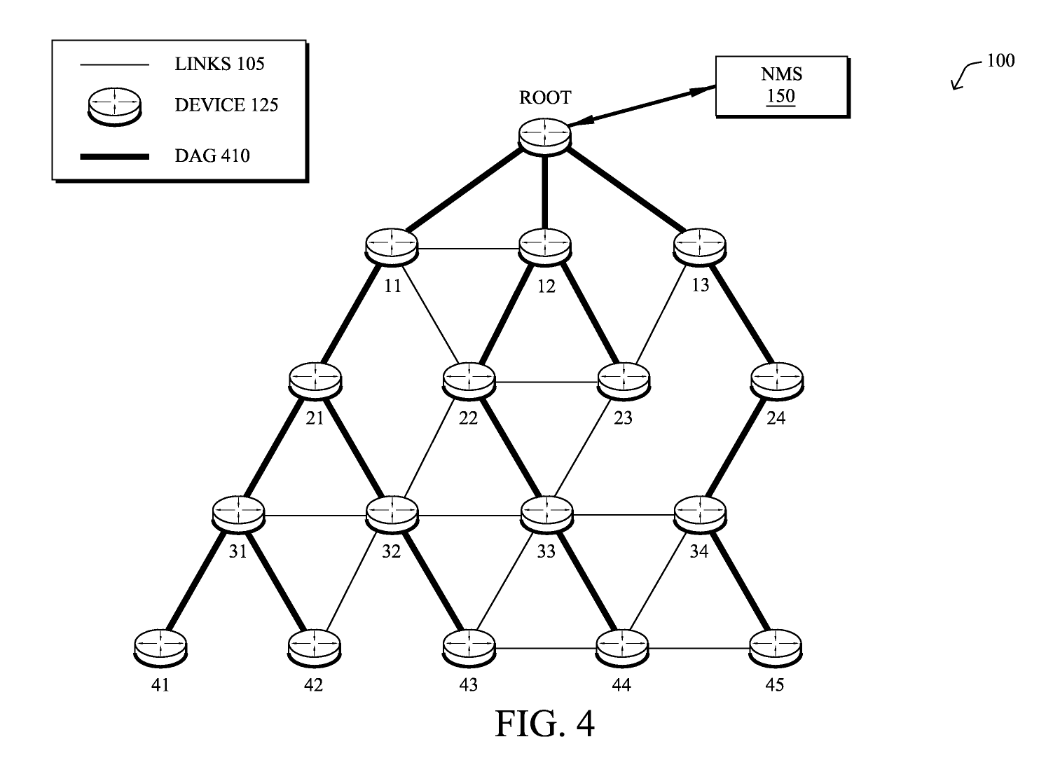

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein.

As noted above, routing requirements of a given network often depend upon the particular applications running in the network. More precisely, the services that operate in the network may define the communication requirements across the network, as each service may have its own reliability, bandwidth, latency, or energy requirements, where the particular devices on which a service is hosted define the communication end-points of a service. Currently, however, such configuration is manual, cumbersome, and non-adaptive.

In particular, supported services within a network are expected to change over time, i.e., new services will be rolled in while old services will be phased out. For example, a Smart Grid Advanced Metering Infrastructure (AMI) deployment may initially support only Automated Meter Reading where traffic primarily flows through one or few DAG roots. However, over time, new applications (e.g., Distribution Automation) may be introduced into the network, and may need updated routing requirements. Furthermore, because the needs of such applications are still to-be-defined, the illustrative Smart Grid AMI platform must be able to adapt over time to support changing requirements.

Service-Based Routing Topology

The techniques herein utilize knowledge obtained from service discovery to trigger routing topology optimizations. In particular, a system in accordance with the techniques herein may achieve this by:

1) Extending service discovery to include and provide routing requirements information (e.g., use of multicast, Objective Functions, etc.);

2) Having a route optimization service (either back-end with NMS 150 or on devices 125 themselves) to monitor existing routing requirements;

3) Dynamically configuring multicast groups for services that indicate the use of multicast communication in their service discovery registration; and

4) Dynamically informing the DAG root, devices hosting a service, or clients of a service to initiate a new local DAG instance (or to modify the existing DAG) with the appropriate Objective Function, metrics, and constraints.

Specifically, according to one or more embodiments of the disclosure as described in detail below, a particular route optimizing device of a computer network (e.g., a network management service or “NMS” 150 or else a device 125 in the network) discovers one or more registered services for the computer network, the registered services indicating one or more corresponding routing characteristics associated with the respective registered service. By comparing the one or more service-related routing characteristics with a current routing characteristic of a routing topology of the computer network (where the routing topology built based on a current routing topology strategy), it can be determined whether to update the routing topology strategy based on the comparison. In response to determining to update the routing topology strategy, one or more devices in the computer network may then be informed of an updated routing topology strategy and associated service-related routing characteristics, where the one or more devices are configured to update the routing topology based on the updated routing topology strategy, accordingly.

Illustratively, the techniques described herein may be performed by hardware, software, and/or firmware, such as in accordance with the service discovery process 248, which may contain computer executable instructions executed by the processor 220 to perform functions relating to the novel techniques described herein, e.g., in conjunction with routing process 244 (and/or DAG process 246). For example, the techniques herein may be treated as extensions to conventional service discovery and routing protocols, e.g., various service insertion architecture (SIA) and RPL protocols, and as such, may be processed by similar components understood in the art that execute those protocols, accordingly.

Operationally, Smart Object devices typically operate unattended, that is, they generally discover and join a network, and then register and obtain network-layer information to effectively participate within the network. In a Smart Grid AMI deployment, for example, devices 125 will register themselves with a Network Management System (NMS) 150 to indicate their presence and obtain configuration information from the NMS. Various protocols may be used to that end, such as that described in the IETF Internet Draft entitled “Constrained Application Protocol (CoAP)”<draft-ietf-core-coap-07>, by Shelby et al. (Jul. 8, 2011 edition).

In a similar fashion, Smart Object devices also register and obtain configuration information for application-layer services. In particular, Smart Objects indicate what services they provide and discover what services are available and what end-points are hosting those services. This process is known as Service Discovery. Today, the NMS 150 may provide such service discovery mechanisms using the known Domain Name Service (DNS) Service Discovery (DNS-SD) or other similar mechanisms.

The most basic form of service discovery simply maps a service name to one or more location(s) that support the service. In most cases, the location is an IP address and port number. In many cases, the service discovery mechanism can also provide additional descriptive information about the service (e.g., a human-readable description, options supported by the service, or specific parameters to use when using the service). Devices populate entries in the service discovery server by registering their services and providing information about the service.

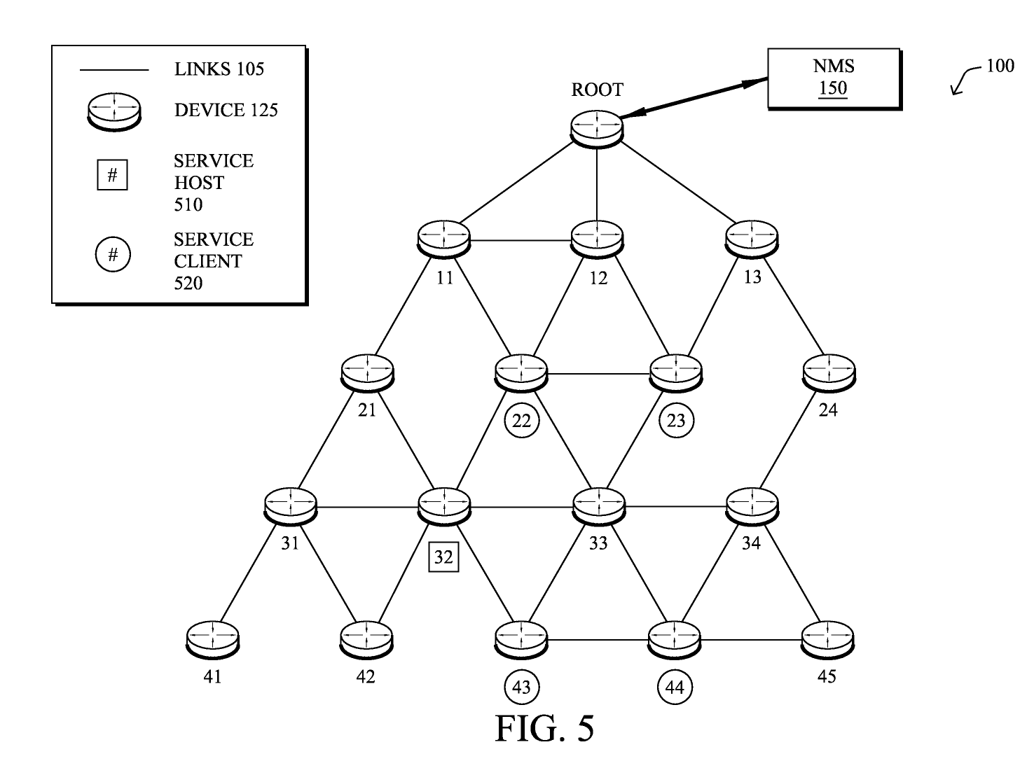

FIG. 5 illustrates an example layout of devices 125 that may operate according to a particular service. For example, one or more devices 125 (e.g., node 32) may be configured as service hosts 510 for the service (i.e., providing the service), while one or more devices (e.g., nodes 22, 23, 43, and 44) may be configured as service clients 520 (i.e., requesting the service).

According to the techniques herein, the conventional service discovery mechanism is extended to include information about routing requirements for the particular services. That is, since service discovery mechanisms may be used to trigger routing topology optimizations, e.g., particularly for LLNs, the registered services may also indicate one or more corresponding routing characteristics associated with the respective registered service. In particular, when a device registers its service(s), it may indicate useful Objective Functions in configuring routes between devices for the particular service and/or whether multicast communication is used to communicate with service end-points for the particular service.

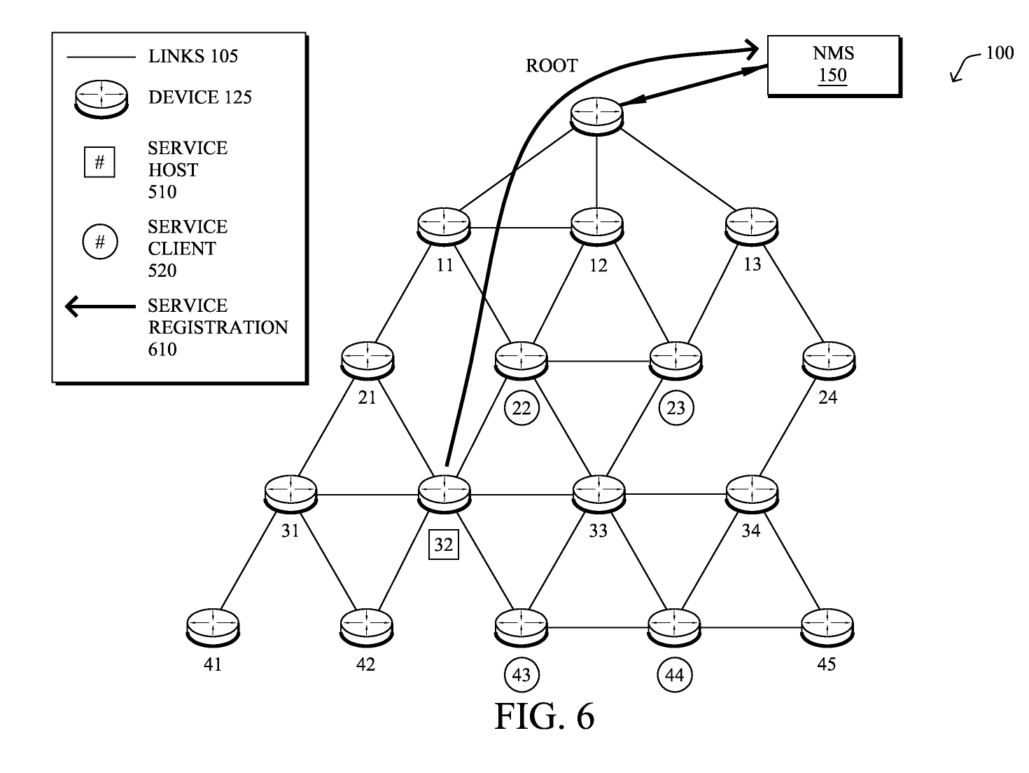

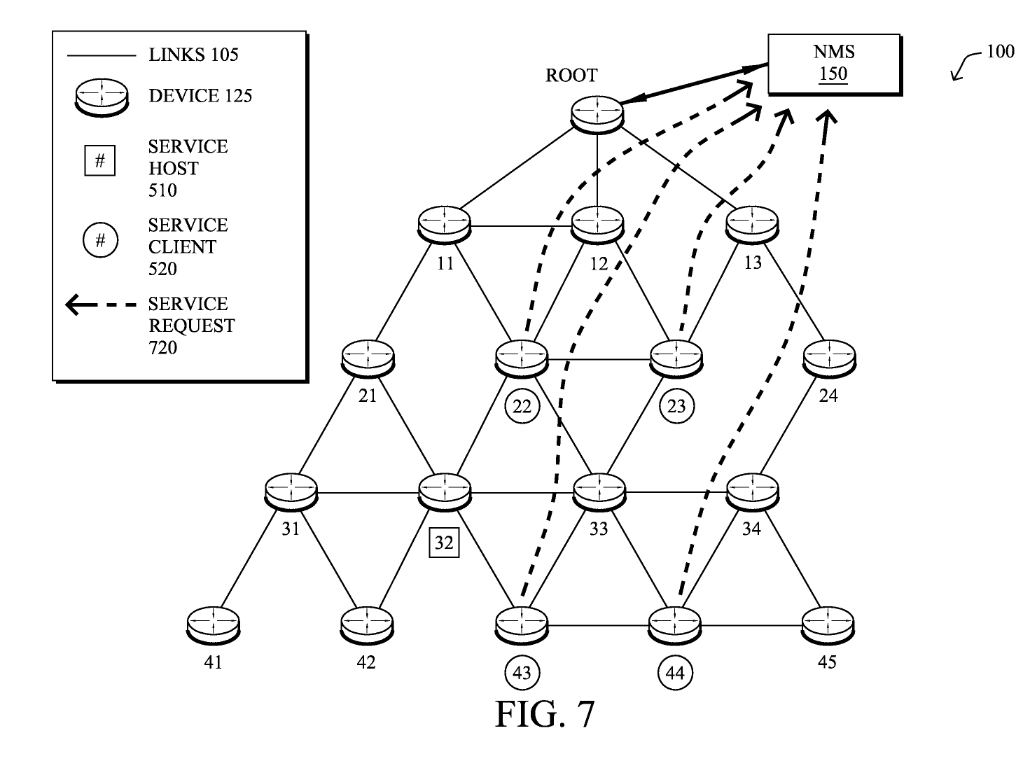

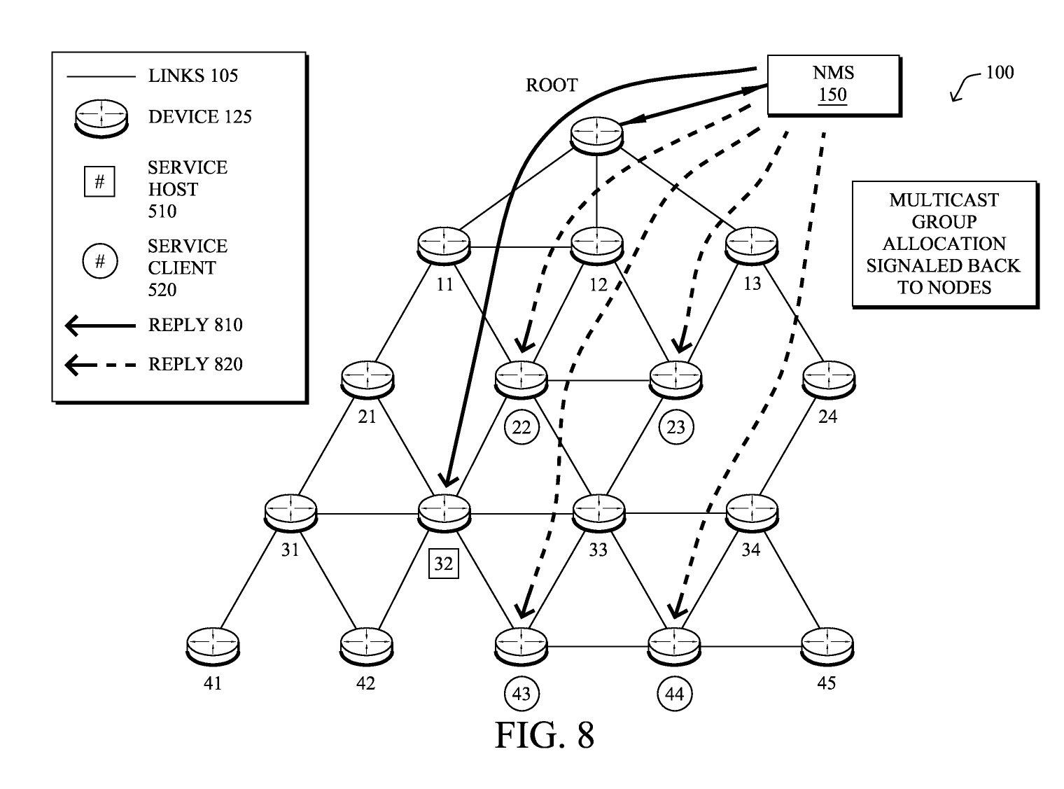

In one embodiment, a service discovery server is a separate entity, such as the NMS 150 or else some other server device (e.g., within the network 100 or else located remotely). As shown in FIG. 6, the service host 510 may send a service registration 610 to a centralized server device to register their service(s) with the server, and as further shown in FIG. 7, devices communicate with the server (with service requests 720) to determine the location of corresponding services within the network. The server (e.g., NMS 150 or otherwise) may then reply to each of the host 510 and clients 520 as shown in FIG. 8 with respective replies 810/820, containing a confirmation of the registration or the requested information, respectively, and according to the techniques herein, additional information such as routing topology strategies and/or associated routing characteristics as detailed below.

Note that in another embodiment, devices may host their own service discovery server (as with DNS-SD). As a result, a device can discover services by sending an IPv6 multicast request message into the network, and the device(s) hosting the service then reply directly to the requesting device.

According to the techniques herein, a route optimization service located on the NMS or else on the individual devices (e.g., the illustrative “service discovery process” 248) uses the routing information obtained through service discovery to trigger routing topology optimizations. In particular, where route optimization is performed by a separate service discovery server (e.g., NMS 150), the server may evaluate the current routing strategy whenever the service registry information changes. The server then indicates any corresponding routing strategy changes as described below to the DAG root or other devices 125 in the network. Conversely, the route optimization may be performed by individual devices 125 within the computer network, where replies 820 to service requests 720 comprise corresponding routing characteristics associated with the respective requested registered service. In this manner, the routing information allows a client device 520 to initiate changes to the routing strategy itself. For example, in the case of RPL, a client device may choose to initiate its own Local DAG and serve as a DAG root, as described below.

In both cases, the service discovery mechanism herein provides helpful information about the use of a service within a network. In addition, while service registration provides an indication of what devices are hosting a services, service discovery requests provide an indication of what devices may utilize such services. As a result, the service discovery mechanism may also be used to determine a number of clients requesting a particular service by indicating what end-points are likely to communicate within a particular service class.

The route optimization service portion of service discovery process 248 (on the NMS 150 and/or devices 125) can then choose whether or not it is beneficial to make any routing topology strategy changes. For example, the route optimization service may determine that the current routing topology is sufficient given the routing requirements specified by the service discovery server and no action is needed. However, if the current routing topology is not sufficient, then the route optimization service may choose to update the routing topology strategy. Said differently, by comparing the service-related routing characteristics with a current routing characteristic of a routing topology of the computer network (e.g., a DAG 410), which was built based on a current routing topology strategy, the route optimization service may determine whether to update the routing topology strategy based on the comparison, e.g., and the number of clients requesting the particular service as mentioned above.

In determining whether or not a new routing topology is beneficial, the route optimization service may also take into account information about available resources on the devices and the expected change in resource consumption for the updated routing strategy. The route optimization service may obtain the resource information from the NMS. In another embodiment, devices can “publish” their resource information as part of the service discovery registration (or reply to a service discovery request).

In response to determining that an update is beneficial, i.e., that the current routing topology is insufficient, the route optimization device may informing one or more of the devices 125 in the computer network of an updated routing topology strategy and associated service-related routing characteristics, such as in the replies 810/820 of FIG. 8. The devices 125 are then configured to update the routing topology based on the updated routing topology strategy, accordingly.

Routing topology strategies, generally, describe the action(s) that should be taken to build (or modify) a corresponding routing topology, e.g., a DAG, such as building a new routing topology instance, modifying a current instance, expanding communication properties (e.g., signal strength, data rates, etc., which may create and/or remove links 105 from the network 100), etc., based on the associated service-related routing characteristics. For example, service-related routing characteristics may be based on characteristics of an objective function, routing metrics, and/or routing constraints, such as, e.g., defining new root nodes, delay requirements, packet loss requirements, diversity requirements, etc. In particular, updated routing topology strategies may instruct the devices 125 of the network to perform any one of the following example actions:
1) Initiate a new DAG instance from the current DAG root with the appropriate Objective Function, routing metrics, and routing constraints;
2) Initiate a new local DAG instance from one or more host devices 510 of the service with the appropriate Objective Function, metrics, and constraints; and
3) Initiate a new local DAG instance from one or more client devices 520 of the service (or non-client devices) with the appropriate Objective Function, metrics, and constraints.

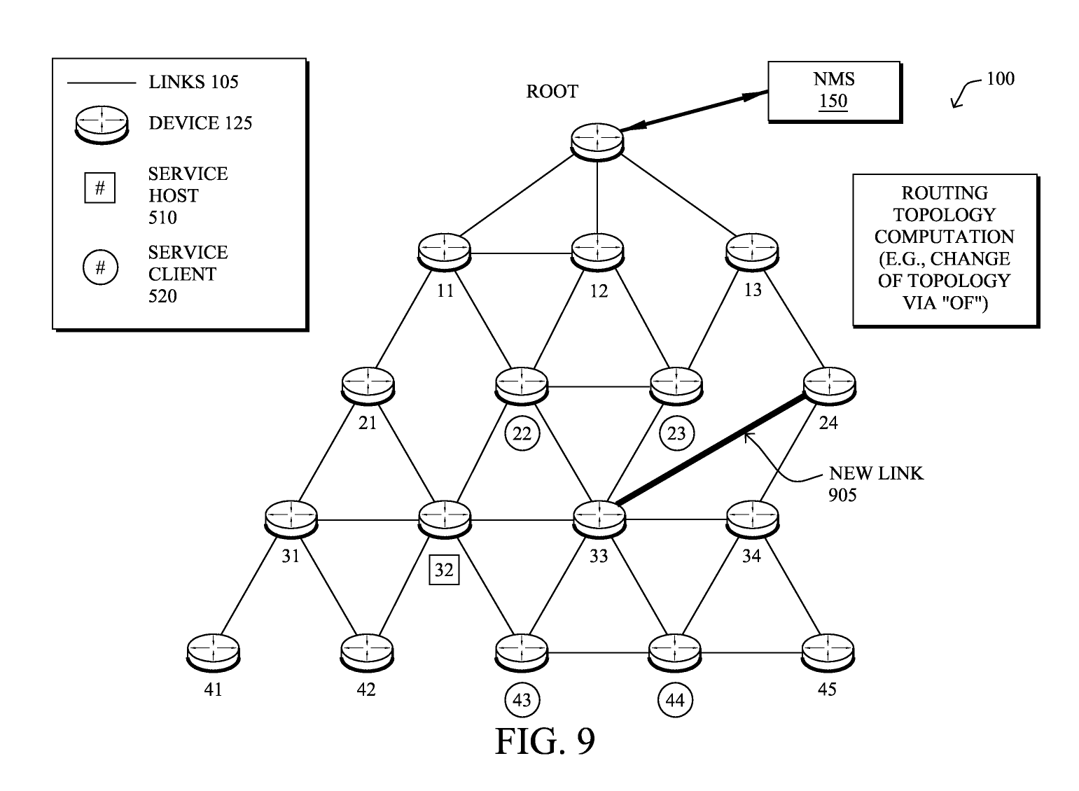

As an illustrative example, assume that the NMS 150, acting as the route optimization service, determines that a majority of the client devices 520 requesting a particular service hosted by node 32 (host 510) are local to node 33. A first component of an updated routing topology strategy may dictate a change to various communication characteristics, e.g., increased transmit power and/or reduced signal strength thresholds, which may be shared by the entire network, or only by one or more devices, such as node 33 as selected by the NMS 150. As shown in FIG. 9, for example, node 33 expands its “reach,” such as based on a new objective function (OF), and a new link 905 may be established between node 33 and node 24 (whether necessary or not).

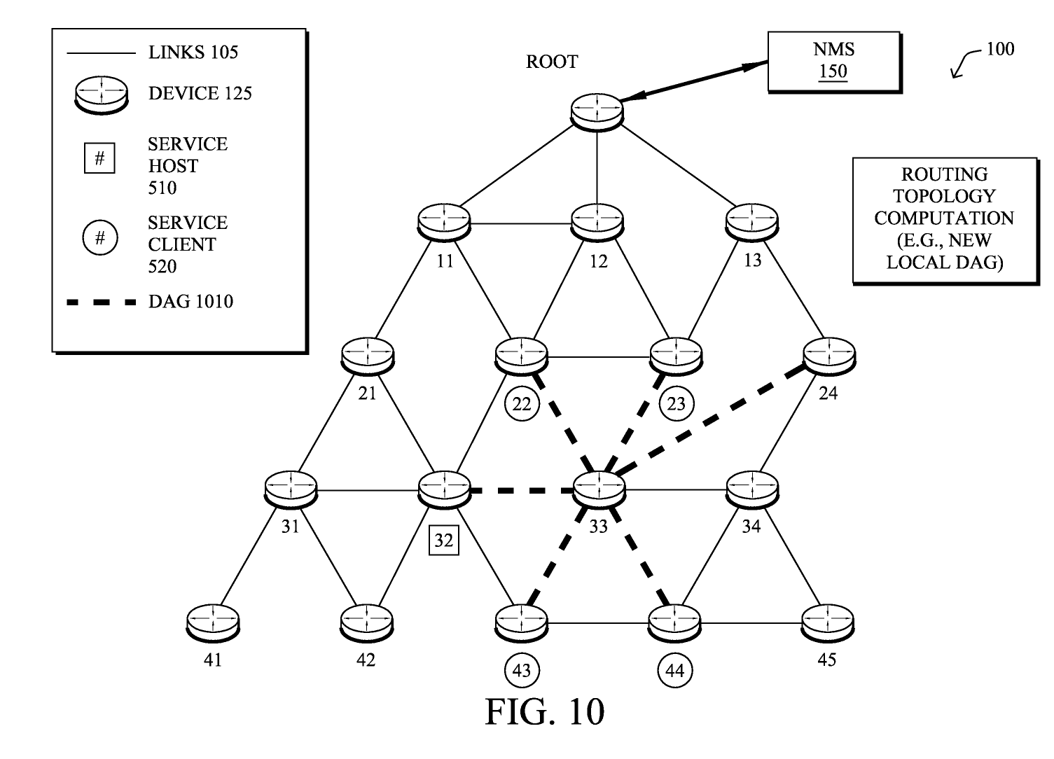

According to another component of the illustrative routing topology strategy, node 33, notably not a client device 520 of node 32's service, may be directed to initialize a local DAG 1010 (as shown in FIG. 10) to include various devices 125 within the network 100, particularly the client devices 520 (e.g., nodes 22, 23, 43, and 44). This new local DAG 1010 may then be used specifically for the service hosted by node 32. Note that node 24 may be included within the local DAG 1010 based on various factors, such as including any local (single-hop) neighbors of the root node, or else other factors, such as based on node characteristics. For example, it is possible that the objective function for DAG 1010 is to include any client device 520 of the service, and any local aggregation devices. Assuming that node 24 is an aggregation device, and node 34 is not, node 24 may be added to the DAG 1010, while node 34 is not.

In addition, according to one or more illustrative embodiments herein, the routing topology strategy may be used to indicate what multicast group(s) should be advertised (e.g., in DAO messages), if any, to support efficient multicast and avoid wasted resources advertising multicast groups that are not important to the service. For instance, a particular service-related routing characteristic may be related to whether multicasting is used for a particular corresponding service. As such, the route optimization service may configure an associated multicast group for the particular corresponding service, such as obtaining a multicast group for the service using any number of allocation methods (e.g. the known Multicast Address Dynamic Client Allocation Protocol, “MADCAP”). The service then informs the service-registering host (e.g., node 32) and one or more corresponding service-requesting clients (e.g., nodes 22, 23, 43, and 44) of the use of the associated multicast group (e.g., via replies 810/820) so that they can subscribe and listen for messages sent to that group. Other devices, such as nodes 33 and 24, may also be informed, if necessary or otherwise desired.

According to the techniques herein, whenever updated registered services are discovered, the corresponding routing topology strategy may also be updated in response, based on the corresponding updated routing characteristics, numbers of devices requesting the service, device characteristics (e.g., available resources), etc. Notably, those skilled in the art will appreciate that the illustrated strategies and characteristics are merely examples, and are not meant to limit the embodiments herein. In particular, there are countless combinations of strategies and associated routing characteristics that may be developed and utilized depending upon the underlying service, the technology available within the network, and any other configurations established by system programmers and administrators. As such, the updates to the routing topology in the future may account for such other combinations that may be made possible through advances in technology and/or made desirable by different objectives of service applications, accordingly.

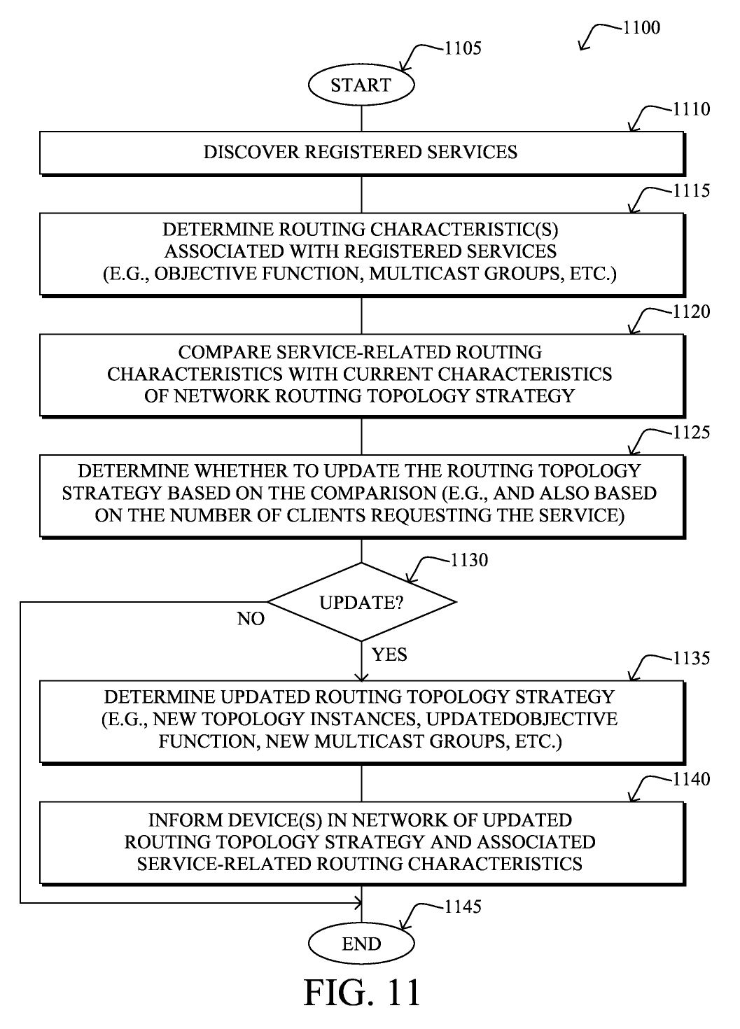

FIG. 11 illustrates an example simplified procedure for building a routing topology using service discovery in a computer network in accordance with one or more embodiments described herein. The procedure 1100 starts at step 1105, and continues to step 1110, where, as described in greater detail above, a route optimization device (e.g., NMS 150, devices 125, etc.) may discover registered services in the network 100. Accordingly, in step 1115, the device determines routing characteristic(s) associated with registered services (e.g., objective function, multicast groups, etc.), and then in step 1120 can compare the service-related routing characteristics with current characteristics of the network routing topology strategy.

Based on the comparison (e.g., and also based on the number of clients requesting the service and capabilities of those devices, as mentioned above), in step 1125 the device determines whether to update the routing topology strategy. If an update would be beneficial in step 1130, then the device may determine an updated routing topology strategy in step 1135, such as directing new topology instances, an updated objective function, assigning new multicast groups, etc., and in step 1140 informs device(s) in network of the updated routing topology strategy and associated service-related routing characteristics, accordingly.

The procedure 1100 illustratively ends in step 1145, though it should be noted that the procedure may return to discover additional services in step 1110, e.g., periodically and/or in response to certain network conditions/events. It should also be noted that while certain steps within procedure 1100 may be optional as described above, the steps shown in FIG. 11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The novel techniques described herein, therefore, build a routing topology using service discovery in a computer network. In particular, the techniques herein combine service discovery and computation of an appropriate routing topology, along with multicast address assignment in certain embodiments. Specifically, a system in accordance with the embodiments herein: 1) optimizes communication paths within a network based on routing requirements of registered services within the network; 2) dynamically configures multicast groups for registered services within the network; and 3) minimizes wasted resources in provisioning a network for services that are not active within a network.

While there have been shown and described illustrative embodiments that build a routing topology using service discovery in a computer network, it is to be understood that various other adaptations and modifications may be made within the spirit and scope of the embodiments herein. For example, the embodiments have been shown and described herein with relation to LLNs, and in particular, to the RPL protocol. However, the embodiments in their broader sense are not as limited, and may, in fact, be used with other types of networks and/or protocols. In addition, while certain types of services and/or corresponding routing characteristics are mentioned herein, other types may be used, accordingly. Also, while the techniques generally describe a separate NMS device 150, the NMS functionality may be located within another device, such as the root device, and thus need not be a separate entity and/or otherwise need not be located outside of the LLN.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
discovering one or more registered services for a computer network, the registered services indicating one or more corresponding routing characteristics associated with the respective registered service;
comparing the one or more service-related routing characteristics with a current routing characteristic of a routing topology of the computer network, the routing topology built based on a current routing topology strategy;
determining whether to update the routing topology strategy based on the comparison; and
in response to determining to update the routing topology strategy, informing one or more devices in the computer network of an updated routing topology strategy and associated service-related routing characteristics, wherein the one or more devices are configured to update the routing topology based on the updated routing topology strategy.

2. The method as in claim 1, wherein a particular service-related routing characteristic is whether multicasting is used for a particular corresponding service.

3. The method as in claim 2, further comprising:
configuring an associated multicast group for the particular corresponding service, wherein informing the one or more devices in the computer network of the updated routing topology strategy and associated service-related routing characteristics comprises informing a service-registering host and one or more corresponding service-requesting clients of the use of the associated multicast group.

4. The method as in claim 1, wherein the service-based routing characteristics are selected from a group consisting of: characteristics of an objective function; routing metrics; and routing constraints.

5. The method as in claim 1, wherein the updated routing topology strategy and associated service-related routing characteristics are directed toward building a new routing topology instance within the computer network.

6. The method as in claim 1, wherein the updated routing topology strategy and associated service-related routing characteristics are directed toward modifying the current routing topology.

7. The method as in claim 1, wherein the one or more devices are selected from a group consisting of: a root node of the routing topology; a client of a particular service; a host of a particular service; and a non-client of a particular service.

8. The method as in claim 1, further comprising:
performing the method by a network management service (NMS) device associated with the computer network.

9. The method as in claim 1, further comprising:
performing the method by a device within the computer network, wherein replies to service requests by the device comprise one or more corresponding routing characteristics associated with the respective requested registered service.

10. The method as in claim 1, further comprising:
updating the updated routing topology strategy in response to discovering one or more updated registered services indicating one or more corresponding updated routing characteristics.

11. The method as in claim 1, further comprising:
determining a number of clients requesting a particular service; and
determining whether to update the routing topology strategy based on the comparison and the number of clients requesting the particular service.

12. The method as in claim 1, wherein the routing topology is a directed acyclic graph (DAG).

13. An apparatus, comprising:
one or more network interfaces to communicate with a computer network;
a processor coupled to the network interfaces and adapted to execute one or more processes; and
a memory configured to store a process executable by the processor, the process when executed operable to:
discover one or more registered services for the computer network, the registered services indicating one or more corresponding routing characteristics associated with the respective registered service;
compare the one or more service-related routing characteristics with a current routing characteristic of a routing topology of the computer network, the routing topology built based on a current routing topology strategy;
determine whether to update the routing topology strategy based on the comparison; and
in response to determining to update the routing topology strategy, inform one or more devices in the computer network of an updated routing topology strategy and associated service-related routing characteristics, wherein the one or more devices are configured to update the routing topology based on the updated routing topology strategy.

14. The apparatus as in claim 13, wherein a particular service-related routing characteristic is whether multicasting is used for a particular corresponding service.

15. The apparatus as in claim 14, wherein the process when executed is further operable to:
configure an associated multicast group for the particular corresponding service, wherein informing the one or more devices in the computer network of the updated routing topology strategy and associated service-related routing characteristics comprises informing a service-registering host and one or more corresponding service-requesting clients of the use of the associated multicast group.

16. The apparatus as in claim 13, wherein the service-based routing characteristics are selected from a group consisting of: characteristics of an objective function; routing metrics; and routing constraints.

17. The apparatus as in claim 13, wherein the updated routing topology strategy and associated service-related routing characteristics are directed toward building a new routing topology instance within the computer network.

18. The apparatus as in claim 13, wherein the updated routing topology strategy and associated service-related routing characteristics are directed toward modifying the current routing topology.

19. The apparatus as in claim 13, wherein the one or more devices are selected from a group consisting of: a root node of the routing topology; a client of a particular service; a host of a particular service; and a non-client of a particular service.

20. The apparatus as in claim 13, wherein the apparatus is a network management service (NMS) device associated with the computer network.

21. The apparatus as in claim 13, wherein the apparatus is a device within the computer network, wherein replies to service requests by the device comprise one or more corresponding routing characteristics associated with the respective requested registered service.

22. The apparatus as in claim 13, wherein the process when executed is further operable to:
update the updated routing topology strategy in response to discovering one or more updated registered services indicating one or more corresponding updated routing characteristics.

23. The apparatus as in claim 13, wherein the process when executed is further operable to:
determine a number of clients requesting a particular service; and
determine whether to update the routing topology strategy based on the comparison and the number of clients requesting the particular service.

24. The apparatus as in claim 13, wherein the routing topology is a directed acyclic graph (DAG).

25. A tangible, non-transitory, computer-readable media having software encoded thereon, the software when executed by a processor operable to:
discover one or more registered services for a computer network, the registered services indicating one or more corresponding routing characteristics associated with the respective registered service;
compare the one or more service-related routing characteristics with a current routing characteristic of a routing topology of the computer network, the routing topology built based on a current routing topology strategy;
determine whether to update the routing topology strategy based on the comparison; and
in response to determining to update the routing topology strategy, inform one or more devices in the computer network of an updated routing topology strategy and associated service-related routing characteristics, wherein the one or more devices are configured to update the routing topology based on the updated routing topology strategy.
